(19) United States
(12) Patent Application Publication
(10) Pub. No.: US 2005/0196040 A1
(43) Pub. Date: Sep. 8, 2005

(54) Image reproducing method, image reproducing apparatus and image reproducing program

(75) Inventor: Hisashi Ohara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/071,445

(22) Filed: Mar. 4, 2005

(30) Foreign Application Priority Data
Mar. 4, 2004 (JP) 2004-060309

(51) Int. Cl. G06K 9/00

(52) U.S. Cl. 382/167

(57) ABSTRACT

A reference image and a target image for image inspection are displayed side by side in a monitor. The reference image is taken in approximately identical shooting condition to the target image for the image inspection, and corrected with a reference correction parameter. The reference correction parameter and the reference image are stored in a memory. The target image for the image inspection is corrected with the reference correction parameter. The operator determines image quality while comparing the reference image to the target image for the image inspection. When the image quality is unsatisfactory, the target image for the image inspection is corrected. When the correction parameter is changed during the image correction, the changed correction parameter is used for correcting the next image instead of the reference correction parameter.

### BACKGROUND OF THE INVENTION

1. Field of the Invention

The present invention relates to an image reproducing method, an image reproducing apparatus and image reproducing program for reproducing and displaying images on a monitor disposed in an information processing terminal such as a personal computer.

2. Background Arts

In order to improve image quality of digital images, it is effective to correct color balance and tone curve by an information processing terminal such as a personal computer (PC) before printing. In that case, an image taken by a digital camera is sent to the PC. While observing the image displayed in a monitor of the PC, an operator carries out image inspection by changing various correction parameters. Thereby, the operator can obtain images with desired finished quality. Further, when a digital camera allows to output RAW image data to the PC without correcting white balance, the image correction can be carried out by the PC so as not to lose color informations in the digital camera.

U.S. Pat. No. 6,633,689 discloses an efficient image correction method which displays plural image frames on a screen and performs the image correction to grouped image frames by one operation with the same or similar correction parameters. According the above method, it is not necessary to perform the image inspection to each of the image frames within the same group. Therefore, it reduces the work of the operator.

U.S. Pat. No. 6,633,689 discloses an art which performs the image correction to all the images within the same group at once. However, the operator needs to manually perform the image inspection to the first image frame. When the image inspection of the first frame is insufficient, there is a possibility that the finished quality of other image frames are insufficient.

When some images are taken in the fairly constant camera setting and composition, such as studio shots for a wedding or product shots, the correction parameters for these images may often take the same values to obtain the desired finished quality. In such cases, it is inefficient to perform the image inspection process to all images.

### SUMMARY OF THE INVENTION

In view of the foregoing, an object of the present invention is to provide an image reproducing method, an image reproducing apparatus and an image reproducing program for obtaining uniform finished quality over all image frames to be inspected.

Another object of the present invention is to provide an image reproducing method, an image reproducing device and an image reproducing program for improving efficiency of image inspection.

In order to achieve the above and other objects, the present invention displays a reference image, which is taken in the approximately identical shooting conditions to a target image for the image inspection and corrected with a reference correction parameter, and a target image for the image inspection side by side in a monitor. The reference correction parameter corrects the reference image to achieve optimal image quality. The target image for image inspection is displayed in the monitor after being corrected with the reference correction parameter.

Further, a reduced image of the target image for the image inspection is included in the screen in which the reference image and the target image for the image inspection are displayed side by side. When the correction parameter to the target image for the image inspection is changed, it is preferable to apply the changed correction parameter to the next image to be corrected. Further, it is preferable to display a status display bar, which shows whether the reduced image is inspected or not, along with the reduced image.

It is possible to use the image, which has been subjected to the image inspection, as the reference image. Further, a correction parameter corresponding to the image, which has been subjected to the image inspection, can be used for the reference correction parameter. It is also possible to use the average of the correction parameters corresponding to the images which have been subjected to the image inspection.

It is possible to configure the screen, which displays the reference image and the target image for image inspection side by side, and the screen, which displays the reduced images in rows, in a switchable manner. Further, it is possible to change the display positions of the reference image and the target image for the image inspection.

The image reproducing apparatus of the present invention comprises a monitor for reproducing and displaying a taken digital image as the target image for the image inspection, and a display means for displaying the reference image, which has been taken in the approximately identical shooting conditions to the target image and corrected previously, and the target image side by side.

Further, the image display program instructs a computer device to execute steps for correcting the image, which is taken in the approximately identical shooting condition to the target image, with the reference correction parameter, and displaying the corrected reference image and the target image for the image inspection side by side in the monitor.

According to the present invention, the reference image, which has been taken in the approximately identical shooting condition to the target image and corrected previously, and the target image are displayed side by side. Therefore, it becomes possible to obtain the intended image with uniform finished quality by correcting the target image to obtain similar finished quality to the reference image. Further, the target image is corrected with the reference correction parameter which is used for correcting the reference image to achieve optimum image quality. The corrected target image and the reference image are displayed side by side. Consequently, the time required for the image inspection is reduced to improve the efficiency.

### BRIEF DESCRIPTION OF THE DRAWINGS

The above objects and advantages of the present invention will become apparent from the following detailed descriptions of the preferred embodiments when read in association with the accompanying drawings, which are given by way of illustration only and thus do not limit the present invention. In the drawings, the same reference numerals designate like or corresponding parts throughout the several views, and wherein:

FIG. 1 is a schematic block diagram showing configurations of a digital camera and a PC for image inspection;

FIG. 2 is an explanatory view showing an image inspection screen;

FIG. 3 is a flow chart showing steps of the image inspection;

FIG. 4 is an explanatory view showing an image inspection screen after adjusting correction parameters; and

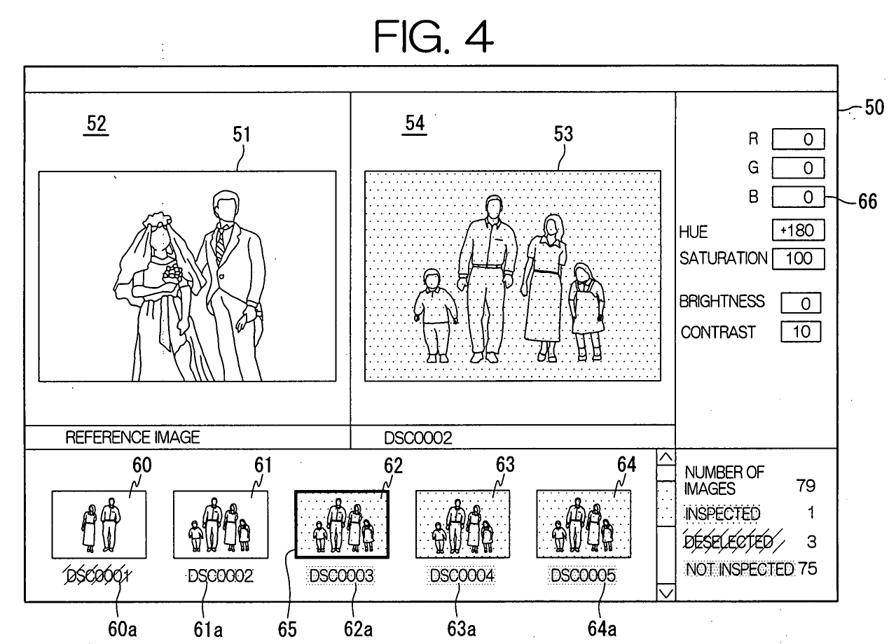

FIG. 5 is an explanatory view showing a list screen.

### DETAILED DESCRIPTION OF THE EMBODIMENT

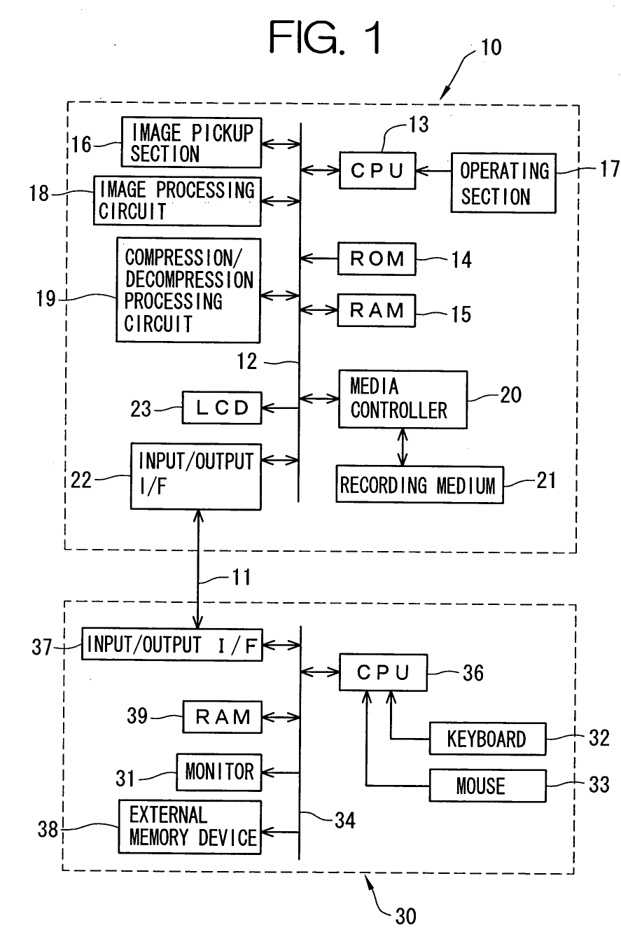

A commercially available personal computer with a pre-installed image reproduction program will be a PC 30 for image inspection. As shown in FIG. 1, a digital camera 10 and the PC 30 for the image inspection are connected via a communication cable 11 to send and receive camera control data and image data for carrying out the image inspection. A USB (Universal Serial Bus) communication cable or an IEEE 1394-compliant communication cable can be used for the communication cable 11. Wireless communication means can also be used for exchanging data instead of the communication cable 11.

Each section of the digital camera 10 is interconnected via a data bus 12, and CPU 13 controls overall operation of the digital camera 10. A program for operating the digital camera 10 is recorded in ROM 14, and is loaded in RAM 15 when the digital camera 10 is turned on. An image-pickup section 16 comprises the known taking lens and a CCD, and photoelectrically converts an optical image of a subject into digital image data. Camera settings, such as aperture and shutter speed, can be set by operating various setting buttons provided in an operating section 17. It is also possible to determine the camera settings by the PC 30 for the image inspection. In that case, the camera settings are sent to the digital camera 10 via the communication cable 11. Further, the camera settings can be stored in an additional PC and loaded in the digital camera 10 by connecting the additional PC to the digital camera 10.

Image data, which is output from the image-pickup section 16, is buffered in the RAM 15. The image data is RAW image data, which has not been subjected to image correction such as white-balance. The RAW image data is constituted of a plurality of pixel data with gradation value of 12 bits per color. An image processing circuit 18 reduces the gradation value to 8 bits per color, and performs the white-balance processing and gradation conversion to the RAW image data according to predetermined conditions depending on each model, and outputs the corrected image data. A compression/decompression processing circuit 19 compresses the corrected image data according to a JPEG (Joint Photographic Coding Expert Group) format, and outputs the compressed image data.

The RAW image data or the compressed image data is recorded in a recording medium 21, such as a memory card, via a media controller 20. After taking a desired number of images, the digital camera 10 is connected to the PC 30 for the image inspection via the communication cable 11. The RAW image data or the compressed image data stored in the recording medium 21 of the digital camera 10 is sent to the PC for the image inspection via an input and output I/F 22. An LCD 23 continuously displays the subject images in a shooting mode, and reproduces and displays the images stored in the recording medium 21 in a reproduction mode.

It is possible to determine whether the RAW image data or the compressed image data to be output at the time of the camera setting. Further, it is also possible to output both the RAW image data and the compressed image data. The following describes an embodiment which outputs the RAW image data alone from the digital camera 10. In the embodiment, the RAW image data is directly sent from the digital camera 10 to the PC 30 for the image inspection via the input and the output I/F 22. However, it is also possible to record the RAW image data in the recording medium 21 and set the recording medium 21 in the PC 30 for the image inspection so as to load the RAW image data to the PC 30 for the image inspection.

The PC 30 for the image inspection reproduces and displays an image on a monitor 31 according to the RAW image data sent from the digital camera 10, and performs various image corrections to the displayed images in response to operation signals input via the input the devices such as a keyboard 32 and a mouse 33. Each section of the PC 30 for the image inspection is interconnected via a data bus 34, and CPU 36 controls overall operation of the PC 30 for the image inspection. The image data sent from the digital camera 10 is recorded in an external memory device 38, such as a hard disk, via an input and output I/F 37 and the data bus 34. The input devices, such as the keyboard 32 and the mouse 33, are operated to perform the image correction to the image data, which will be described later, and to set the camera settings of the digital camera 10.

An image reproduction program is installed in the external memory device 38 of the PC 30 for the image inspection via memory media such as a CD-ROM, a DVD-ROM and the like, or the Internet. When the keyboard 32 and the mouse 33 are operated, the image reproduction program is loaded into the RAM 39 and executed.

The external memory device 38 of the PC 30 for the image inspection stores reference image data and reference correction parameters. The reference image data corresponds to a reference image which has been taken in the approximately identical camera setting and subjected to proper image correction.

The parameter used for correcting the reference image become the reference correction parameter. The reference image can be obtained by shooting an arbitrary subject immediately after a photo studio has been set up or at the predetermined intervals, and correcting the images to achieve desirable finished quality. In the embodiment, the correction parameter obtained by correcting the reference image is set to be a reference correction parameter.

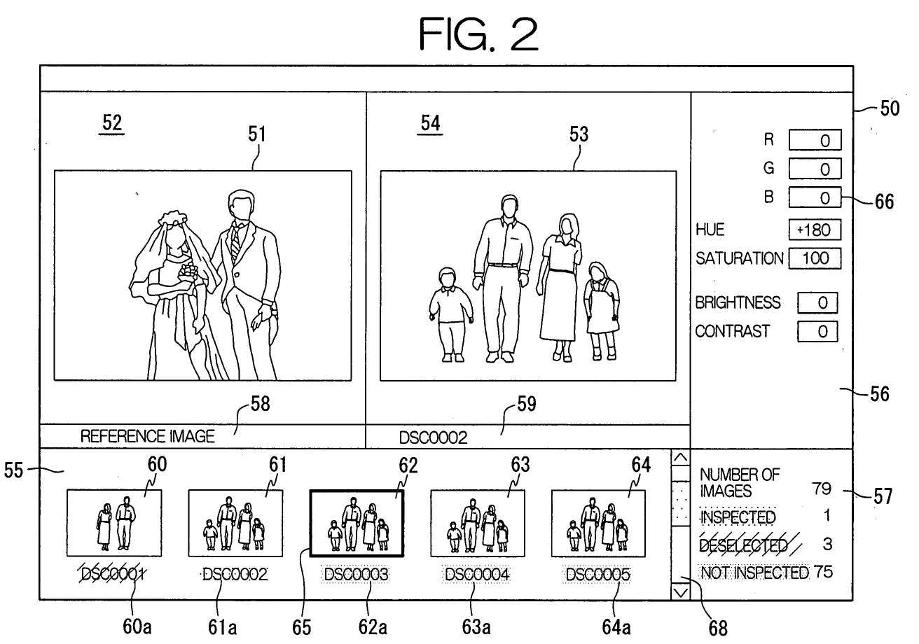

When the image reproduction program is executed, an inspection screen 50 shown in FIG. 2 is displayed in the monitor 31. The inspection screen 50 has a reference image display area 52 for displaying a reference image 51, a target image display area 54 for displaying a target image 53 for the image inspection, a thumbnail image display area 55 for displaying thumbnail images (reduced images) in a row, a parameter adjustment area 56 and an inspection status display area 57. Images, which are displayed in the target image display area 54 and the thumbnail image display area 55, are generated by correcting the RAW image data with the reference correction parameters. Further, the image is based on the display image data which has been converted into Tiff (Tagged Image File Format) with the gradation value of 16 bits per color, for instance.

As shown in FIG. 2, the reference image display area 52 and the target image display area 54 are arranged side by side so as to correct the target image 53 while comparing with the reference image 51. Further, title bars 58 and 59 are disposed below the reference image display area 52 and the target image display area 54 respectively to display a title (a file name) of each image.

In the thumbnail image display area 55, plural thumbnail images 60-64 are displayed in a row. In an example shown in FIG. 2, five thumbnail images are displayed. However, it is possible to increase or decrease the number of thumbnail images in the same display-area as necessary. Further, a selecting cursor 65 is highlighted around a thumbnail image 62, which corresponds to the target image 53, to associate the target image 53 with the thumbnail image 62. On the right side of the thumbnail image display area 55, a scroll bar 68 is provided to scroll the screen in up-and-down directions. When there are six and above thumbnail images, the sixth and above images can be displayed by sliding the scroll bar 68 in the up-and-down directions.

Status display bars 60a-64a are displayed below the thumbnail images 60-64 respectively to show whether the image correction has been performed or not. The status display bars 60-64a are overlaid to the title names (the file names) of the corresponding thumbnail images 60-64 respectively. For instance, the status display bars 60-64a are displayed in three different patterns with different colors and densities for showing the statuses: the thumbnail image has already been inspected, the thumbnail image has not been inspected and the thumbnail image is deselected from the inspection.

An example shown in FIG. 2, the subject and the composition of a first image (DSC0001) 60 are different from these of other four images (DSC0002-DSC005) 61-64, so the first image (DSC001) 60 is deselected from the image inspection using the keyboard 32 and the mouse 33. In that case, the status display bar 60a is displayed in the color and the density which correspond to the deselected status. The image correction has already been performed to the second image (DSC002) 61, so the status display bar 61a is displayed in the color and the density which correspond to the inspected status. Further, the image inspection have not been performed to the third to fifth images (DSC003-DSC0005) 62-64, so the status display bars 62a-64a are displayed in the color and the density which correspond to the not-inspected status. Thus, it becomes easy to visually identify the inspection status of each image.

In the inspection status display area 57, the number of all image frames loaded in the RAM 39 from the external memory device 38 (number of images), the number of the inspected image frames (inspected), the number of the deselected image frames (deselected), and the number of the images, which have not been inspected yet (not inspected), are displayed.

Values of the correction parameters, such as color balance (each color of red, green and blue, hue and saturation), brightness and contrast are displayed in the parameter adjustment area 56. The values of the correction parameters can be changed by inputting a value in each input box 66 which corresponds to each of the correction parameters. When the correction parameters are changed, all the images, which correspond to not-inspected images, are corrected with the changed parameters at once. The corrected images are displayed in the inspection screen 50. Further, parameters used for color tone curve, gamma correction, white balance correction, hyper-tone processing and hyper-sharpness processing can be changed besides the parameters used for correcting the color balance and the contrast.

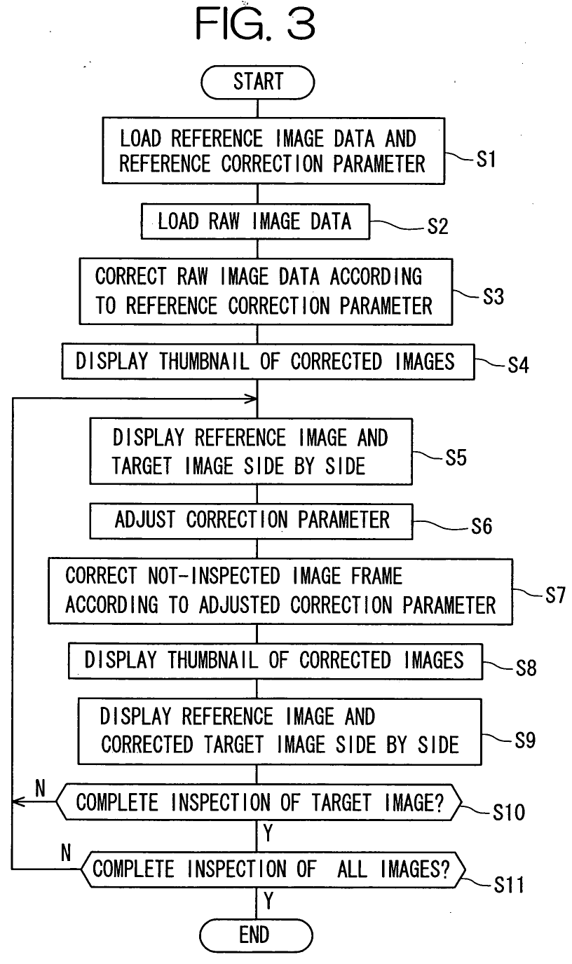

An operation according to the above configuration is described using a flowchart shown in FIG. 3. When the image reproducing program is executed, the reference image data and the reference correction parameters are loaded in the RAM 39 (S1). Next, the RAW image data stored in the external memory device 38 are loaded in RAM 39 sequentially (S2). The RAW image data are subjected to the image correction with the reference correction parameters and converted into the display image data (S3). Then, the thumbnail image data are generated by thinning out the display image data, and displayed in the thumbnail display area 55 of the inspection screen 50 (S4). Further, the reference image and the first image, which is the target image for the image inspection, are displayed side by side (S5). The displaying order of the images is changeable.

If the images are taken when illumination, field angle, the subject and camera position are fixed, the proper correction parameters to these images may often take the same values. The image is automatically generated with the desired finished quality by correcting the shot image with the reference parameters. Therefore, the operator can complete the image inspection only by checking the image after the image correction. Thus, the time for the image inspection is reduced. When the target image corrected with the reference correction parameters are determined to be satisfactory, the corrected target image is stored in the external memory device 38 in the corrected state. Otherwise, the corrected image is sent from the PC 30 for the image inspection to the printer and printed.

When the finished quality of the image corrected with the reference correction parameters are unsatisfactory, the operator changes the correction parameters so as the target image 53 for the image inspection resemble in quality of the reference image 51. The finished quality of the reference image 51 will also accord to the target image 53 since the shooting condition of the target image 53 is approximately identical to that of the reference image 51. Therefore, the operator can obtain the image with the desired finished quality only by slightly adjusting the correction parameter.

When each of the correction parameters is changed (S6), the target image 53 for the image inspection displayed in the monitor 31 and other images indicated as “not-inspected” are corrected with the changed correction parameter to be converted into the display images (S7). Then, the thumbnail images are generated by thinning out the image data of the displayed images, and the displayed images before the image correction are updated (S8). The target image 53 corrected with the changed corrected parameter, and the reference image 51 are displayed side by side (S9). Thereby, the changes in the correction parameter are reflected to the target image 53 and the thumbnail images 62-64 indicated as “not-inspected”, which will be inspected later.

When the image inspection is completed for one image frame (S10), the operator selects the next image frame and performs the image inspection. In the studio shooting, most of the images are taken in the identical scene. Therefore, in most cases, the images with the desired finished quality is obtained by correcting the first image frame and applying the same correction parameters as the first image frame to the remaining image frames. In that case, the time required for the image inspection can be reduced since it is not necessary to perform the image inspection to each image frame. Further, the image inspection has been carried out by using the identical correction parameters, which enable to bring out the approximately uniform finished quality of the image.

Hereinafter, every time the correction parameter is changed, the image correction is performed to the image frames specified as not-inspected by using the changed correction parameter as described above. The corrected image is displayed in the inspection screen 50. When the image inspection has been applied to all the not-inspected image frames (S11), the image inspection is completed, and display image data of the corrected image is outputted. The display image data is loaded in the printer, and the corrected image is printed. Otherwise, the corrected image is written in the recording media such as the CD-ROM.

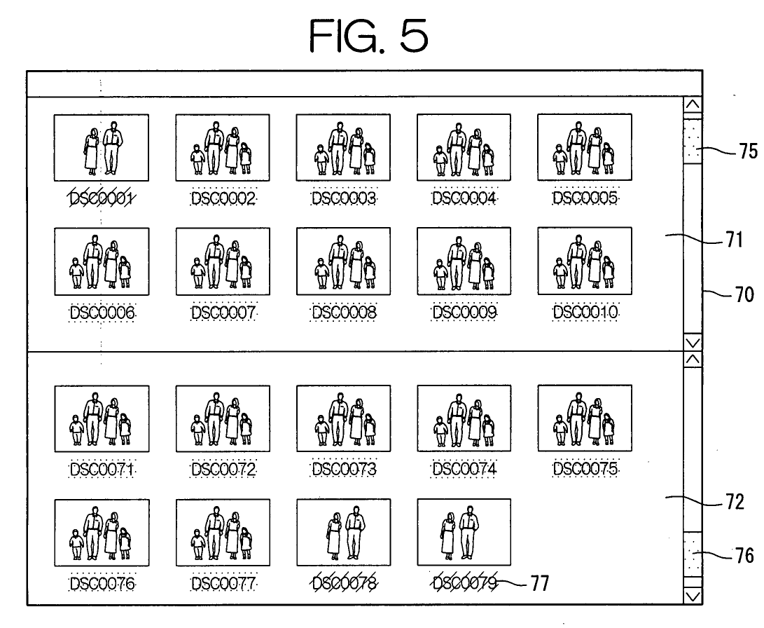

Subjective determination of the operator may vary during the image inspection, which results in different finished quality between the first inspected image frame and the last inspected image frame. Therefore, it is preferable to configure the inspection screen 50 shown in FIG. 2 and a list screen 70 shown in FIG. 5 switchable. In the list screen 70, thumbnail image display screens 71 and 72, which divide the list screen 70 in upper and lower sections, are displayed as shown in FIG. 5. In each thumbnail image display area 71 and 72, ten thumbnail images at maximum are concurrently displayed, for instance. When there are more thumbnail images to be concurrently displayed, such thumbnail images can be displayed by sliding scroll bars 75 and 76 displayed on the right side of each thumbnail image display area 71 and 72.

The first inspected image frame is displayed in the upper thumbnail image display area 71 and the last inspected image frame is displayed in the lower thumbnail image display area 72 by operating the scroll bars 75 and 76. Thereby, it becomes easy to check if there is a difference in the finished quality between the first inspected image frame and the last inspected image frame. Further, it becomes easy to visually identify whether the image inspection has been performed by overlaying a status display bar 77 on each title of the thumbnail images.

In the above embodiment, the RAW image data is subjected to the image correction, converted into the display image data and displayed in the monitor. However, the present invention can be applied to the case where the display image data (in the bitmap format or in JPEG format) is corrected, reproduced, and displayed.

It is also possible to transpose the reference image display area and the target image display area. For instance, the display property of the monitor is not uniform across the screen due to shading and the like. Further, the image may be viewed differently between the right and left eyes of the operator. Even in such cases, the corrected image can be properly checked by transposing the reference image display area and the target image display area.

In the studio shooting, the digital camera is often set in a fixed position by using a tripod. In that case, it is possible to carry out the shooting in a state that the digital camera is connected to the PC for the image inspection.

Although the present invention has been described with respect to the preferred embodiment, the present invention is not to be limited to the above embodiment but, on the contrary, various modifications will be possible to those skilled in the art without departing from the scope of claims appended hereto.

1. An image reproducing method for reproducing a target image for image inspection in a monitor, said target image for said image inspection being a digital image taken by a camera, said image reproducing method comprising the steps of:
taking at least one reference image in the identical shooting condition to said target image for said image inspection;
correcting said reference image with a reference correction parameter; and
displaying said corrected reference image and said target image for said image inspection side by side in said monitor.

2. An image reproducing method as claimed in claim 1, said method further comprising the step of correcting said target image for said image correction with said reference correction parameter before displaying said target image for said image inspection in said monitor.

3. An image reproducing method as claimed in claim 2, wherein said reference image is taken by said camera which is used for taking said target image for said image inspection.

4. An image reproducing method as claimed in claim 2, wherein display positions of said reference image and said target image for said image inspection are changeable in said monitor.

5. An image reproducing method as claimed in claim 2, wherein said reference correction parameter is obtained when correcting said reference image to be of achieve optimum finished quality.

6. An image reproducing method as claimed in claim 2, wherein said reference image is said digital image which has been subjected to said image inspection.

7. An image reproducing method as claimed in claim 2, wherein said at least one of said reference images is one of said plural digital images, which have been subjected to said image inspection, and said reference correction parameter is an average of correction parameters applied to said plural digital images.

8. An image reproducing method as claimed in claim 2, wherein when said target image for said image inspection displayed in said monitor is further corrected, a next image to be inspected is corrected with a correction parameter corresponding to said further correction and displayed in said monitor.

9. An image reproducing method as claimed in claim 8, said image reproducing method further comprising the step of displaying said plural digital images taken by said camera as reduced images in said monitor along with said reference image and said target image for said image inspection.

10. An image reproducing method as claimed in claim 9, wherein said plural reduced images are reduced images of said target images for said image inspection, and reduced images of digital images taken before and/or after said target image for said image inspection.

11. An image reproducing method as claimed in claim 10, said image reproducing method further comprising the step of displaying a status display bar along with said reduced image in said monitor for displaying whether said reduced image is inspected or not.

12. An image reproducing method as claimed in claim 2, wherein said image reproducing method further comprising the step of switching between a first display screen for displaying said reference image and said target image for said inspection in said monitor, and a second display screen for displaying said plural reduced images in said monitor.

13. An image reproducing method as claimed in claim 12, wherein said second display screen is divided into a first display area and a second display area, wherein said first display area displays reduced images at an early stage of said image inspection, and said second display area displays plural reduced images at a final stage of said image inspection.

14. An image reproducing method as claimed in claim 13, said image reproducing method further comprising the step of displaying a status display bar, which shows whether said reduced images are inspected or not, along with said reduced images in said monitor.

15. An image reproducing apparatus for reproducing a target image for image inspection, said target image being a digital image taken by a camera, said image reproducing apparatus comprising:
a memory device for storing reference image and a reference correction parameter, said reference image is a digital image taken in the approximately identical shooting condition to said target image;
a correcting device for correcting said reference image with said reference correction parameter after loading said reference image and said reference correction parameter from said memory device; and
a monitor for displaying said corrected reference image and said target image for said image inspection side by side.

16. An image reproducing apparatus as claimed in claim 15, wherein said correcting device corrects said target image for said image inspection with said reference correction parameter before displaying said target image for said image inspection in said monitor.

17. An image reproducing apparatus as claimed in claim 16, wherein said reference correction parameter is displayed in said monitor in a changeable state to correct said displayed target image for said image inspection.

18. An image display program for allowing a computer as an image reproducing apparatus to display a target image for image inspection in a monitor, said target image being a digital image taken by a camera, said image display program comprising the steps of:
correcting said reference image with a reference correction parameter; and
displaying said reference image and said target image for said image inspection side by side in said monitor.

19. An image display program as claimed in claim 18, wherein said image displaying program further comprising the step of correcting said target image for said image inspection with said reference correction parameter before displaying said target image for said image inspection in said monitor.

20. An image display program as claimed in claim 19, wherein said reference image is taken by said camera which is used for taking said target image for said image inspection.
